(19) United States
(12) Patent Application Publication
(10) Pub. No.: US 2017/0307871 A1
(43) Pub. Date: Oct. 26, 2017

(54) AEROSPACE/EARTH OBSERVATION/MONITORING MODULE INTEGRATED WITH A PROTECTION SYSTEM AGAINST ATMOSPHERIC AGENTS

(71) Applicant: Officnia Stellare S.R.L., Sarcedo (VI) (IT)

(72) Inventors: Giovanni DAL LAGO, Carré (VI) (IT); Gianluca CAROTTA, Pedemonte (VI) (IT)

(73) Assignee: Officina Stellare S.r.l., Sarcedo (VI) (IT)

(21) Appl. No.: 15/510,209

(22) PCT Filed: Aug. 28, 2015
(86) PCT No.: PCT/EP2015/069732

§ 371 Date: Mar. 9, 2017

(30) Foreign Application Priority Data
Sep. 9, 2014 (IT) MI2014A001562

(51) Int. Cl. G02B 23/16; E04B 1/343; E04B 1/346; E04H 3/00

(52) U.S. Cl. CPC G02B 23/16; E04B 1/346; E04B 1/34305; E04H 3/00

(57) ABSTRACT

Module for observation/monitoring (1) comprising: a supporting mount (2); a telescope (3) rotatably supported by said mount (2); and an opening shelter (4), also supported by said mount (2); said shelter (4) enclosing said telescope (3) within a housing volume (5) when in a closed configuration and clearing a line-of-sight access of the telescope (3) to the external environment when in an open configuration.

### FIELD OF APPLICATION

The present invention relates to an aerospace/earth, observation/monitoring module, automatic and remotely managed.

The invention therefore finds useful application in the field of astronomical instruments.

### BACKGROUND ART

The telescopes of limited size, often improperly identified as amateur telescopes in order to distinguish them from large telescopes, are available on the market in a variety of models adapted to the most various needs of leisure or research.

The smallest and mostly widespread instruments are portable and generally supported by a tripod placed on the ground; on the other hand, larger devices require a stable installation, which moreover ensures a unique reference system in the course of the subsequent observations.

The telescopes, particularly if stably anchored to the ground, must be possibly shielded from ambient surrounding light, in order to allow better visibility of the stars; it is also necessary to provide a shelter from atmospheric agents which would damage them when not in use and affect the mechanical adjustments in the course of the observations.

To achieve these purposes, containment structures are generally used, which may be true domes similar to those of the large telescopes or to constructions of other type, for example sheds with a roof tipper.

These structures define a shelter from the ravages of weather over periods of non-use, while during the observations they provide at least partially a shield by the surrounding light and possible gusts of wind.

Structures of this type are described for example in the article by Molinari Emilio et al. “The new TNG-DIMM: calibrations and first date anaysis”, published in “Proceedings of SPIE, SPIE—International Society for Optical Engineering, US”, vol. 8444, Sep. 13, 2012, pp. 844,462 to 844,462, and in the following documents of prior art patents U.S. Pat. No. 6,151,840 A; U.S. Pat. No. 2,996,844 A; U.S. Pat. No. 3,421,004 A; and GB 340 667 A.

While substantially responding to the needs of the field, said structures may nevertheless have a substantial drawback due to their considerable size, as well as the need of preparing mechanical means for entraining in rotation the entire protective structure.

The technical problem of the present invention is therefore that of devising an observation-monitoring module which allows to solve the prior art drawbacks, already lamented before.

### SUMMARY OF THE INVENTION

The aforementioned technical problem is solved by an observation-monitoring module comprising: a supporting mount rotatable about a main axis; a telescope rotatably supported by said mount according to at least a secondary axis; and an opening shelter.

The shelter encloses the telescope within a housing volume when in a closed configuration, and clears a line-of-sight access of the telescope to the external environment, when in an open configuration.

The shelter is supported by said mount and rotates integrally thereto according to the main axis.

The telescope is in particular rotatable about the secondary axis between a rest position, entirely comprised within said housing volume, and a plurality of observation positions, non entirely comprised within said housing volume, so that access to said telescope observation positions is possible only with the shelter in the open configuration.

The housing volume defined by said shelter features a median cross-section orthogonal to the secondary axis, vertical in the preferred embodiment, provided with a first dimension, preferably the height, greater than a maximum length of the telescope, and with second dimension, preferably the width, smaller than said maximum length of the telescope.

The telescope is preferably oriented along the main axis when in the rest position, said telescope being hinged to a fork of the mount about the secondary axis orthogonal to said main axis.

The shelter is preferably integral with the fork, which is rotatably mounted, about said main axis, on top of a base of the mount, so as to realize a traditional altazimuth mount.

The shelter preferably comprises two lateral portions shielding the telescope from the sides—in particular from the surrounding light, but also from possible gusts of strong wind in the open configuration.

The shelter also comprises at least one sliding portion that covers the telescope in the closed configuration and moves aside with respect to this—preferably sliding parallel to the secondary hinging axis of the telescope itself—in the open configuration.

The sliding portions are preferably in number of two, slidingly connected with the aforementioned lateral portions. Alternatively, the use of a single panel laterally sliding is possible. In a still alternative embodiment, the lateral portions themselves may be movable so as to define two half-shells that enclose the telescope when in contact.

The observation-monitoring module preferably includes remote-controllable actuation means provided both for maneuvering the telescope and for bringing said shelter from the closed configuration to the open configuration and the other way around.

The astronomical observation module is also preferably provided with at least one signal port for a digital or analog connection to a planetarium.

Further characteristics and advantages will become more apparent from the detailed description given hereinafter of a preferred but non exclusive embodiment of the present founding, with reference to the annexed figures in an exemplary but non limiting way.

### BRIEF DESCRIPTION OF THE DRAWINGS

FIG. 1 is a front view of the observation/monitoring module according to the present invention in an open configuration;

FIG. 2 is a lateral view of the observation/monitoring module according to FIG. 1;

FIG. 3 is a plan view of the observation/monitoring module surveillance of FIG. 1;

FIG. 4 is a perspective view of observation/monitoring module of FIG. 1;

FIG. 5 is a front view of the observation/monitoring module according to the present invention in a closed configuration;

FIG. 6 is a plan view of the observation/monitoring module of FIG. 5;

FIG. 7 is a perspective view of the observation/monitoring module of FIG. 5;

FIG. 8 is a lateral view of the observation/monitoring module according to the present invention with the shelter removed to allow viewing of the internal components;

FIG. 9 is a front view of the observation/monitoring module of FIG. 8.

### DETAILED DESCRIPTION

With reference to the accompanying figures, generally indicated with 1 is an observation/monitoring module to the present invention.

The observation/monitoring module 1 comprises a telescope 3 mounted in a known per se manner on a mount 2.

With the term telescope here the swiveling organ is meant, generally of cylindrical shape, which includes the optical instrumental component and the relative observation instrumentation; while with mount a structure is meant supporting in an articulate way the telescope itself.

The telescope 3 may comprise different optical systems and/or cameras of a per se known type, whose detailed description is beyond the scope of this specification. Purely by way of example, it is noted that in a preferred embodiment of the present invention the telescope 3 can have a main optical system with a Ritchey-Chretien configuration with an aperture of 40 cm, possibly accompanied by other viewing systems integrated, comprising for example a wide angle camera for viewing the entire sky.

The mount 2, of altazimuth type, has a base 21 on which, according to a main axis of rotation x, a fork 20 is rotatably mounted, which supports the telescope 3, hinged about a secondary axis of rotation y, orthogonal to the previous one.

The mount 2 is equipped with electric actuators remotely controlled which allow the robotic orientation of the telescope 3. An electronic central control unit, preferably provided with pointing and tracking systems known in the art, drives the automatic movement of the telescope 3.

The mount 2 further carries cables with output signals from the telescope, which allow the transmission of optical data obtained by observation to an external user. In particular, the astronomical observation module 1 provides an output signal, for example an LAN output, intended to be connected to a storage-processing system.

The relevant aspect of the present invention is made by the opening covering system, hereinafter identified as a shelter 4.

Said shelter 4 comprises in particular two fixed lateral portions 40 and two sliding portions 41 compared with these, which are raised above a pedestal 22 which connects the arms 23 of the fork 20 in order to define a box-like containment structure of the telescope 3. The entire box-like structure has an elongated shape, developing in a direction parallel to the secondary axis previously identified.

The two lateral portions 40 have the shape of fixed half-shells which surround the two arms 23 of the fork, by protecting the actuators installed in correspondence of these. The two lateral portions 40 are in a mutual spaced relation, and the telescope 3 is rotatably mounted in the inter-space that separates them.

The movable portions 41 are telescopically mounted onto the lateral portions 40.

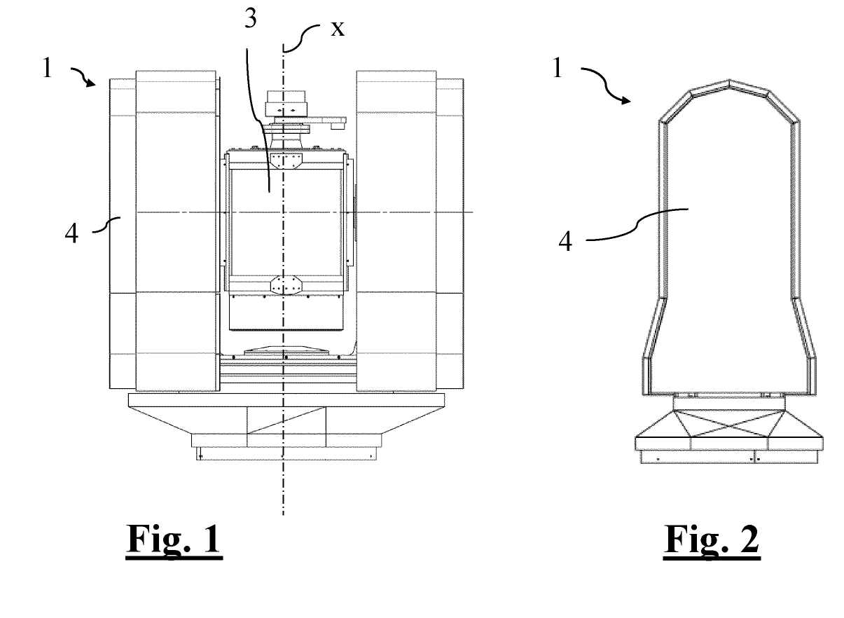

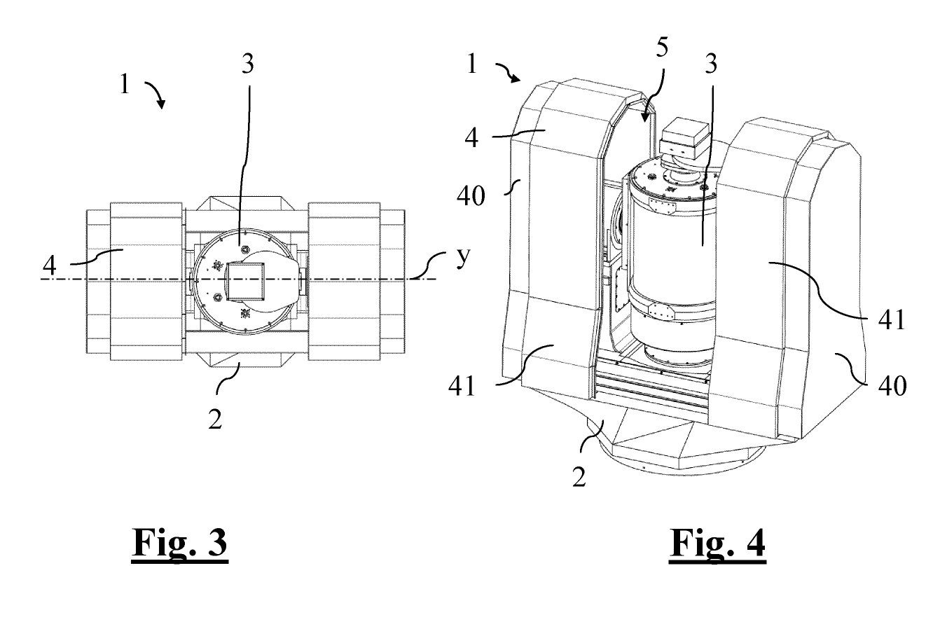

In an open configuration of the device, shown in FIGS. 1-4, these remain retracted on the lateral portions 40 themselves, so that the inter-space between the lateral portions is free.

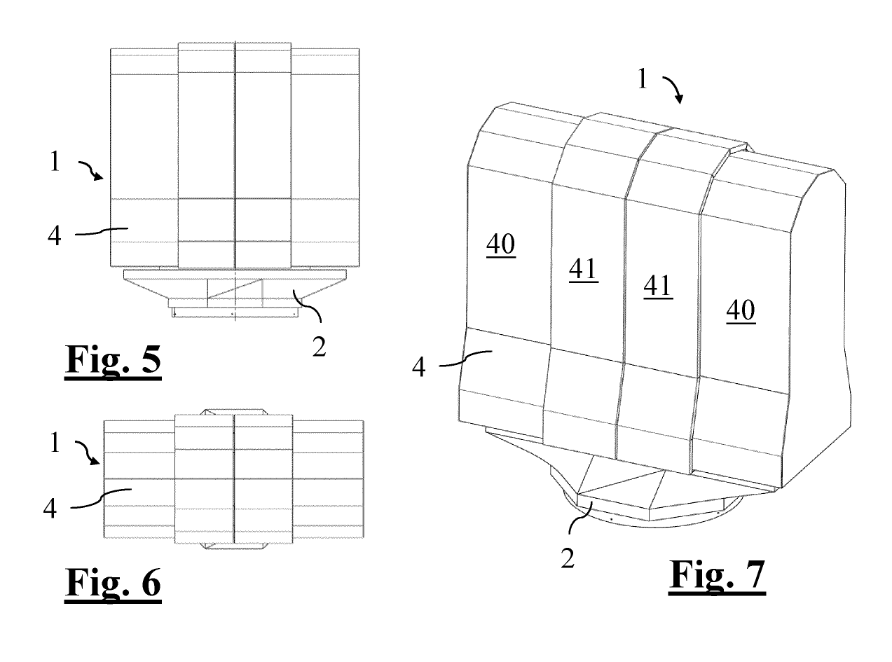

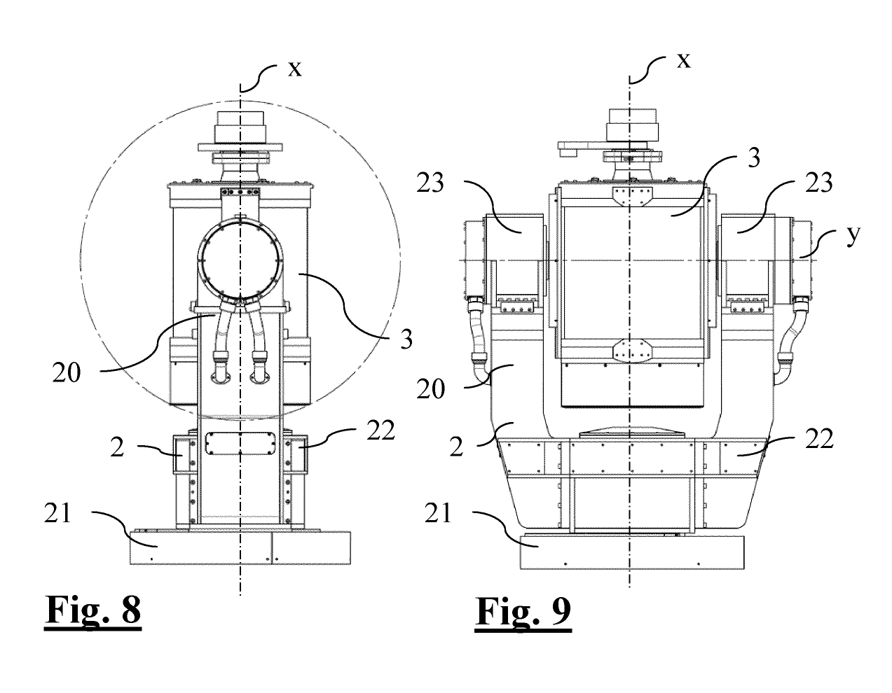

In a closed configuration of the device, shown in FIGS. 5-7, these slide instead in order to cover the aforesaid inter-space, sealing the telescope 3 within a housing inner volume 5. Appropriate gaskets guarantee the tightness of such volume.

The actuation means which promote the relative sliding of the overlapped portions 40, 41 can be of various types, for example they may include an electric motor and a pinion-rack couple. Horizontal rails can be suitably provided on the pedestal 22 in order to drive the sliding portions 41 during their translational motion.

It is noted, unlike what happens with the domes, the sliding portions 41 of the shelter 4 are closed a short distance from the telescope 3, which must be placed in a rest position, that is, oriented parallel to the main axis x. The angular excursion of the telescope 3 itself around the secondary axis y is only possible when the shelter 4 is in an open configuration.

In other words, the shelter 4 defines a shaped case around the telescope 3 in its rest position. This allows to obtain an extremely compact module.

An advantage of the present invention is due to its extreme compactness outlined before, allowing to install the instrument even on roofs and terraces.

Yet another advantage lies in the great ease of installation of the module, which can be marketed as a single pre-assembled unit.

Obviously, with the invention described above, one person skilled in the art, in order to satisfy contingent and specific requirements, may make numerous modifications and variants, all however within the protective scope of the invention as defined by the following claims.

1. A module for aerospace/earth observation/monitoring comprising:
a supporting mount rotatable about a main axis (x);
a telescope rotatably supported by said mount according to at least a secondary axis; and
an opening shelter;
said shelter enclosing said telescope within a housing volume when in a closed configuration and clearing a line-of-sight access of the telescope to the external environment when in an open configuration;
wherein said shelter is supported by said mount and rotates integrally thereto about the main axis; wherein said telescope is rotatable about the secondary axis between a rest position, entirely comprised within said housing volume, and
a plurality of observation positions, non entirely comprised within said housing volume, so that the access to the telescope to said observation positions is possible only with the shelter in an open configuration.

2. The module for aerospace/earth observation/monitoring according to claim 1, wherein the housing volume defined by said shelter features a median cross-section orthogonal to the secondary axis, having a first dimension greater than a maximum length of the telescope and of a second dimension smaller than said maximum length of the telescope.

3. The module for aerospace/earth observation/monitoring according to claim 2, wherein said median cross-section is a vertical median cross-section, said first dimension being the height and said second dimension being the width.

4. The module for aerospace/earth observation/monitoring according to claim 1, wherein said telescope is oriented along a main axis when in rest position, said telescope being hinged to a fork of the mount about a secondary axis orthogonal to said main axis.

5. The module for aerospace/earth observation/monitoring according to claim 4, wherein said shelter is integral with said fork which is rotatably mounted, about said main axis, on top of a base of the mount.

6. The module for aerospace/earth observation/monitoring accordinf claim 1, wherein said shelter comprises two lateral portions shielding the telescope from the sides in the open configuration.

7. The module for aerospace/earth observation/monitoring according to claim 6, wherein said shelter comprises at least a sliding portion that covers the telescope in the closed configuration and moves aside with respect to it in the open configuration.

8. The module for aerospace/earth observation/monitoring according to claim 7, wherein said portion is sliding parallel with the secondary hinging axis of said telescope.

9. The module for aerospace/earth observation/monitoring according to claim 7, wherein said sliding portions are in number of two, slidingly connected with the lateral portions.

10. The module for aerospace/earth observation/monitoring according to claim 1, comprising remote-controllable actuation means provided for maneuvering the telescope and for bringing said shelter from the closed configuration to the open configuration and the other way around.

11. The module for aerospace/earth observation/monitoring according to claim 1, provided with at least one signal port for connection with a remote driving and/or digital data transfer system.
